(19) United States
(12) Patent Application Publication
(10) Pub. No.: US 2023/0072017 A1
(43) Pub. Date: Mar. 9, 2023

(54) DOSING SYRINGE AND RELATIVE ADAPTER

(71) Applicant: PLATINUM PHARMA SERVICE S.R.L.S., Citta' Sant'Angelo (IT)

(72) Inventor: Alfredo RICCI, Citta' Sant'Angelo (IT)

(73) Assignee: PLATINUM PHARMA SERVICE S.R.L.S., Citta' Sant'Angelo (IT)

(21) Appl. No.: 17/794,156

(22) PCT Filed: Jan. 22, 2021
(86) PCT No.: PCT/IB2021/050484

§ 371 Date: Jul. 20, 2022

(30) Foreign Application Priority Data
Jan. 24, 2020 (IT) 102020000001387
Feb. 4, 2020 (IT) 102020000002170

(51) Int. Cl. A61J 1/20; A61J 1/22

(52) U.S. Cl. CPC A61J 1/2096; A61J 1/2048; A61J 1/22

(57) ABSTRACT

A dosing syringe including a hollow cylindrical body and a plunger sliding within the hollow cylindrical body. The hollow cylindrical body includes a main body and a proximal end provided with an aperture. The main body has at least one portion having a cross-section smaller than that of the proximal end, whereby a surface is delimited between the main body and the proximal end, which is configured to abut against a corresponding surface of an adapter, so that the proximal end is removable and liquid-tight blocked between said surface of the adapter and a bottom wall provided with an aperture of the adapter, the aperture of the proximal end and the aperture of the bottom wall being in direct fluid communication therebetween. An adapter for use with a dosing syringe as defined above and an administration kit including the dosing syringe and the relative adapter are also provided.

### Technical Field

The present invention generally relates to the technical field of dosing syringes. More particularly, the present invention relates to a dosing syringe provided with a connection for an adapter for coupling the syringe with a bottle or vial containing a product, typically a drug, to be administered, and a relative adapter for coupling the dosing syringe with the bottle or vial.

### Background

Dosing syringes are widely used to administer doses of drugs, particularly to children and/or subjects with poor mobility in the hands. They represent a growing market, both because of the rise of people with mobility problems in the upper limbs and because the issue of proper dosage of drugs is increasingly felt by both pharmaceutical companies and users.

A dosing syringe typically comprises a hollow, preferably transparent, cylindrical body and a plunger sliding within the hollow cylindrical body to allow the aspiration into the hollow cylindrical body, and subsequently the delivery from the hollow cylindrical body, of a predetermined dose of drug. The plunger is provided with a head adapted to allow a user to impart the force necessary to make the plunger slide within the hollow cylindrical body and the hollow cylindrical body has an end, pointed or flat, provided with an aperture for aspirating and dispensing the dose of drug. A graduated scale is also reported on the outer surface of the cylindrical body, which allows the user to aspirate only the required dose of drug.

In order to aspirate the desired dose of drug into the dosing syringe, for example a dose of syrup to be administered to a child of about 2-3 years of age, the person in charge of administering the drug, for example the mum, inserts one end of the syringe into a vial containing the drug, by acting on the plunger, she aspirates the desired amount of drug, extracts the end of the syringe from the vial and, by acting on the plunger again, she administers the aspirated amount to the child.

During the step of extraction of the syringe from the vial, the outer surface of the end of the syringe, previously immersed in the vial, remains wet with drug, which, during the administration step, could drip, dirtying the child or the mum, objects placed nearby or the floor. In addition, the child could be administered a higher dose of drug than that aspirated and measured, which also includes the amount of drug present on the outer surface of the dosing syringe.

To overcome this drawback, it is known to use an adapter, which is tightly coupled to the opening of the vial containing the drug to be administered. To aspirate the desired dose of drug, the end of the dosing syringe to be inserted into the vial is coupled to the adapter. Thanks to the tightness provided by the adapter, during the step of aspiration of the drug into the dosing syringe, the vial can be raised and overturned, partially or totally, so as to position it above the dosing syringe and facilitate the aspiration action.

Dosing syringes of known type provided with an adapter, whether they have a pointed or flat end, nevertheless have some drawbacks.

Dosing syringes with pointed end are disadvantageous because, and with particular reference to the administration of syrup, the pointed end could hit parts of the mouth, typically the lips and/or tongue, of a child or a person with limited facial movements, causing pain and minor injuries. Moreover, the pointed end can be gripped with difficulty between the lips of the subject to whom the drug is to be administered, which complicates the administration of the drug.

In the case of dosing syringes with flat end, it can happen that the end instead penetrates the vial, passing past the adapter, getting soiled with drug, which can then drip both inside the adapter and outside the hollow cylindrical body of the dosing syringe. Moreover, these dosing syringes do not guarantee the tightness between the adapter and the hollow cylindrical body, so that, when the vial is turned upside down to aspirate the drug, part of the drug could filter through the gap between the adapter and the hollow cylindrical body, with a consequent waste of drug and further soiling of the syringe and adapter.

### SUMMARY

The main object of the present invention is therefore to provide a dosing syringe and a relative adapter, capable of overcoming the drawbacks mentioned above with reference to dosing syringes and adapters of known type.

More particularly, the main object of the present invention is to provide a dosing syringe and a relative adapter, configured so as to allow the aspiration of all the product contained in a vial or bottle, thus preventing the product from being wasted and an amount of product higher than that desired from being administered.

Yet another object of the present invention is to provide a dosing syringe, and a relative adapter, configured so as to ensure their mutual liquid-tight coupling.

Yet another object of the present invention is to provide a dosing syringe configured to be comfortable for the subject to whom the product is to be administered and which does not cause pain and minor injury to the subject.

Another object of the present invention is to provide a dosing syringe and a relative adapter which can be manufactured in a timely and cost-effective way and which are also easy and immediate to use.

These and other objects, which will appear more clearly in the continuation of the present description, are achieved by a dosing syringe, an adapter and an administration kit according to the independent claims 1, 7 and 16. Preferred characteristics of the dosing syringe and adapter are set forth in the dependent claims, from 2 to 6 and from 8 to 15, respectively.

The invention therefore relates, in a first aspect thereof, to a dosing syringe comprising a hollow cylindrical body and a plunger sliding within the hollow cylindrical body, the hollow cylindrical body comprising a main body and a proximal end provided with an aperture.

The dosing syringe is characterized in that the main body has at least one portion having a cross-section smaller than that of the proximal end, whereby a surface is delimited between the main body and the proximal end, which is configured to abut against a corresponding surface of an adapter, so that the proximal end is removable and liquid-tight blocked between said surface of the adapter and a bottom wall provided with an aperture of the adapter, the aperture of the proximal end and the aperture of the bottom wall being in direct fluid communication therebetween.

The invention relates, in a second aspect thereof, to an adapter for use with a dosing syringe as defined above, the adapter comprising a hollow cylindrical body and a flange projecting from the hollow cylindrical body.

The adapter is characterized in that it comprises a bottom wall provided with an aperture, for abutment of the proximal end of the dosing syringe, and an annular tooth, extending internally to the hollow cylindrical body and above the bottom wall, thereby delimiting an annular abutting surface of the abutment surface of the hollow cylindrical body of the dosing syringe.

In a third aspect thereof, the invention relates to a kit for administering a product in liquid or semi-liquid form comprising a dosing syringe and an adapter as defined above.

The dosing syringe and the adapter configured according to the present invention advantageously allow a perfect liquid-tightness between the syringe and the adapter, during the step of aspiration of a drug from a vial. In particular, during the drug aspiration step, the inner surfaces of the adapter and the outer surface of the proximal end of the dosing syringe do not come into contact with the drug which passes from the vial to the hollow cylindrical body of the dosing syringe by sliding through the apertures in direct fluid communication of the adapter and syringe. This advantageously allows, in particular during the step of aspiration of the drug into the hollow cylindrical body of the dosing syringe, to avoid any soiling of the outer surface of the proximal end of the dosing syringe and of the inside of the adapter housing it, and therefore the dripping during the step of administration of the drug.

Moreover, the dosing syringe and the adapter according to the present invention are advantageously configured to engage each other precisely and safely, during the step of aspiration of the drug from the vial, allowing, at the same time, an easy and convenient disengagement of the dosing syringe from the adapter, once the desired dose of drug has been aspirated.

In the following of the present description, and in the appended claims, the term “proximal” will refer to portions of the various components of the dosing syringe and adapter which are directed, in use, toward the body of a user of the administered product, while the term “distal” will refer to portions of the various components of the dosing syringe and of the adapter which are directed, in use, away from the body of a user of the administered product.

### BRIEF DESCRIPTION OF THE DRAWINGS

Further characteristics and advantages of the present invention will become clearer from the following detailed description of its preferred embodiments, given below, by way of non-limiting example, with reference to the attached drawings. In the drawings:

FIG. 1 is a perspective view of a dosing syringe according to a first preferred embodiment of the present invention;

FIG. 2 is an enlarged perspective view of a detail of the dosing syringe of FIG. 1;

FIG. 3 is a perspective view of the detail of FIG. 2, seen from another angle;

FIG. 4 is a perspective view of an adapter according to a preferred embodiment of the present invention, for use with the dosing syringe of FIG. 1;

FIG. 5 is a perspective and a longitudinal sectional view of the adapter of FIG. 4;

FIG. 6 is a perspective view of the dosing syringe of FIG. 1 coupled to the adapter of FIG. 4;

FIG. 7 is a front view of the dosing syringe of FIG. 1 coupled, through the adapter, to a vial containing a drug to be aspirated and administered;

FIG. 8 is a partial longitudinal sectional view of the coupled dosing syringe and adapter, according to a plane passing through the minor axis of the hollow cylindrical body of the dosing syringe;

FIG. 8a is an enlarged view of the detail circled in FIG. 8;

FIG. 9 is a partial longitudinal sectional view of the coupled dosing syringe and adapter, according to a plane passing through the major axis of the hollow cylindrical body of the dosing syringe, with the plunger in the step of aspiration of the drug from a vial;

FIG. 9a is an enlarged view of the detail circled in FIG. 9;

FIG. 10 is a perspective view of a dosing syringe and an adapter in accordance with a second embodiment of the present invention, shown coupled together;

FIG. 11 is a view, similar to that of FIG. 8, of the dosing syringe and of the adapter of FIG. 10;

FIG. 12 is a view similar to that of FIG. 9 of the dosing syringe and of the adapter of FIG. 10;

FIG. 13 is an enlarged and longitudinal sectional perspective view of a detail of a dosing syringe according to a third embodiment of the present invention;

FIG. 14 is a partial longitudinal sectional view of the detail of FIG. 13 coupled to a relative adapter;

FIG. 15 is an enlarged perspective view of a detail of a dosing syringe according to a fourth embodiment of the present invention;

FIG. 16 is a partial longitudinal sectional view of the detail of FIG. 15 coupled to a relative adapter;

FIG. 17 is an enlarged perspective view of a detail of a dosing syringe according to a fifth embodiment of the present invention;

FIG. 18 is a partial longitudinal sectional view of the detail of FIG. 17;

FIG. 19 is a partial longitudinal sectional view of the detail of FIG. 17 coupled to a relative adapter;

FIG. 20 is an enlarged perspective view of a detail of a dosing syringe according to a sixth embodiment of the present invention;

FIG. 21 is a partial perspective and longitudinal sectional view of the detail of FIG. 20; and

FIG. 22 is a partial longitudinal sectional view of the detail of FIG. 20 coupled to a relative adapter.

### DETAILED DESCRIPTION OF THE EMBODIMENTS

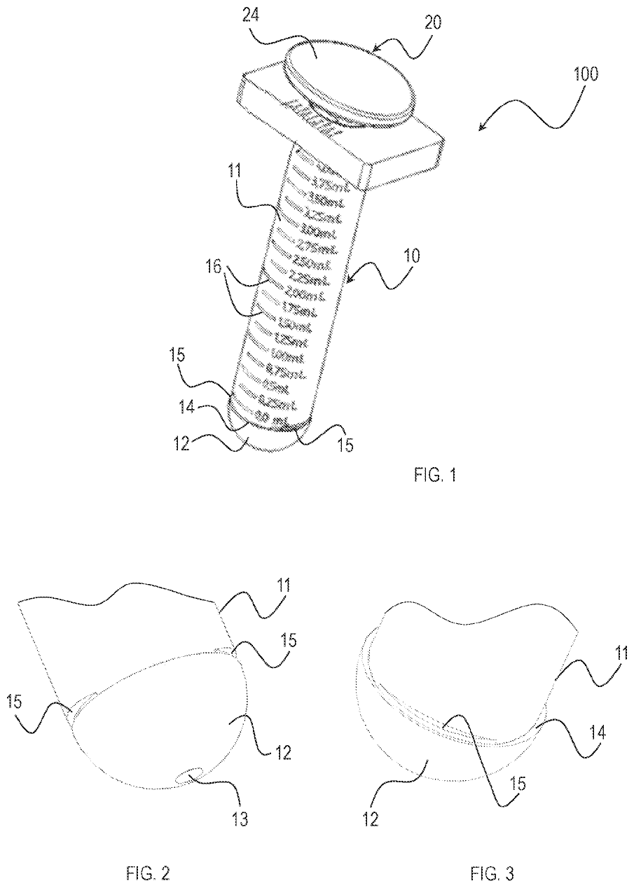

With reference to FIGS. 1 to 3, they show a dosing syringe according to a preferred embodiment of the present invention.

The dosing syringe, generally designated by the reference numeral 100, comprises a hollow cylindrical body 10, typically transparent, adapted to contain a volume of a product or drug to be dispensed, and a plunger 20 sliding within the hollow cylindrical body 10 to aspirate into the hollow cylindrical body 10, and then dispense from the hollow cylindrical body 10, the desired volume of product.

The hollow cylindrical body 10 comprises a main body 11, inside which the plunger 20 slides, and a proximal end 12, that is, turned, in use, toward the body of a user of the administered product, provided with an aperture 13 for aspirating/dispensing the product into/from the hollow cylindrical body 10 of the dosing syringe 100. Preferably, a series of measuring notches 16 is reported on the main body 11 of the hollow cylindrical body 10, each notch being accompanied by a number indicating the volume of product in millilitres. The proximal end 12 of the hollow cylindrical body 10 is hemispherical, while the main body 11 has an elliptical cross-section.

The plunger 20 also has an elliptical cross-section and a head 24 is formed at a distal end thereof, that is, turned, in use, away from the body of the user of the administered product which is adapted to allow a user of the dosing syringe to grasp the syringe and to exert on the plunger 20 the force necessary to make it slide within the hollow cylindrical body 10, both during the step of aspiration and during the step of dispensing of the product into/from the dosing syringe 100.

As shown in detail in FIGS. 2 and 3, the minor axis of the elliptical cross-section of the main body 11 is smaller than the outer diameter of the hemispherical proximal end 12. while the major axis of the elliptical cross-section of the main body 11 is equal to or smaller than the outer diameter of the hemispherical proximal end 12.

As a result, a preferably plane surface 14 is defined at the zone of passage from the hemispherical proximal end 12 to the main body 11 of the hollow cylindrical body 10 and which extends orthogonally to a longitudinal axis of the dosing syringe 100. Moreover, since the cross-section of the main body 11 is elliptical, the surface 14 has a non-uniform transverse extension, i.e. variable along the perimeter of the main body 11 of the hollow cylindrical body 10.

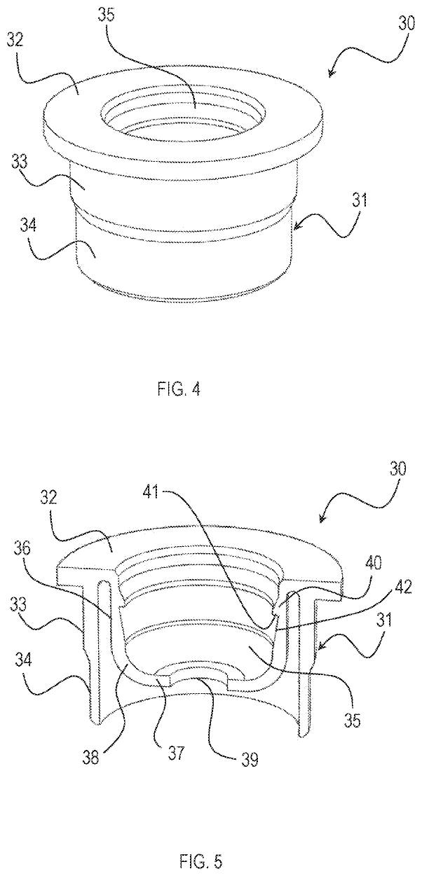

During the step of coupling the dosing syringe 100 with an adapter 30, shown in detail in FIGS. 4 and 5, the surface 14 is configured to abut against a corresponding plane annular surface of the adapter 30.

More particularly, in the case where the minor axis of the elliptical cross-section of the main body 11 is smaller than the outer diameter of the hemispherical proximal end 12 and the major axis of the elliptical cross-section of the main body 11 is equal to the outer diameter of the hemispherical proximal end 12, the abutment surface 14 is shaped like two moon segments facing each other. Conversely, in the case where both the minor axis and the major axis of the elliptical cross-section of the main body 11 are smaller than the outer diameter of the hemispherical proximal end 12, the abutment surface 14 is an annular surface, which has a greater radial extension at the minor axis of the elliptical cross-section of the main body 11 and a smaller radial extension at the major axis of the elliptical cross-section of the main body 11.

In order to allow a releasable coupling between the dosing syringe 100 and the adapter 30, at least one groove 15 is formed on the external surface of the main body 11, immediately above said abutment surface 14, extending along a perimeter length of the main body 11 at one of the two ends of the major axis of the elliptical cross-section thereof.

In the shown embodiment, two grooves 15 are provided, preferably symmetrical and identical between them, each extending along a peripheral length of the main body 11 at a respective end of the major axis of the elliptical cross-section thereof.

With reference to FIGS. 4 to 7, they show an adapter according to a first preferred embodiment of the present invention.

The adapter, generally designated by the reference numeral 30, is configured to be inserted into the opening 52 of a vial 50 containing the drug to be administered. The hemispherical proximal end 12 of the dosing syringe 100, described and shown above with reference to FIGS. 1 to 3, is then coupled onto the adapter 30 to aspirate the desired amount of drug to be administered. When the drug is aspirated from the vial, the dosing syringe 100 is disengaged from the adapter and used for administering the drug.

In particular, the adapter 30 therefore comprises a hollow cylindrical body 31 and a flange 32 projecting at the top from the hollow cylindrical body 31 and configured to abut, in use, against the opening 52 of the vial 50 in which the adapter 30 is inserted.

The hollow cylindrical body 31 has a first portion 33, extending below from the flange 32, followed by a second portion 34. The first portion 33 has an outer diameter substantially corresponding to the inner diameter of the opening 52 of the vial 50 so that, when the adapter 30 is inserted in the vial, the first portion 33 achieves a liquid-tight coupling between the adapter and the vial. The second portion 34 has an outer diameter smaller than the outer diameter of the first portion 33, and therefore smaller than the inner diameter of the opening 52 of the vial, so as to facilitate the insertion of the adapter 30 into the vial.

The adapter 30 also has, inside it, a seat 35 for housing by releasable snap-fit the hemispherical proximal end 12 and a proximal portion of the main body 11 of the hollow cylindrical body 10 of the dosing syringe 100. The seat 35, in addition to allowing the releasable coupling between the dosing syringe and the adapter, advantageously prevents the hemispherical proximal end 12 of the hollow cylindrical body 10 of the dosing syringe 100 from coming into contact with the product contained in the vial, getting soiled. It is therefore possible to aspirate all the product contained in the vial, advantageously avoiding an undesired waste of product.

For this purpose, the inner seat 35 comprises a side wall 36 and a bottom wall 37, preferably plane and with rounded edge 38. The bottom wall 37 is provided with a central aperture 39 having a diameter different from the diameter of the aperture 13 of the hemispherical proximal end 12 of the dosing syringe. In the shown embodiment, the diameter of the aperture 39 of the bottom wall 37 is greater than the diameter 13 of the hemispherical proximal end 12. However, alternatively, it is possible to provide conversely for the diameter of the aperture 39 of the bottom wall 37 to be smaller than the diameter 13 of the hemispherical proximal end 12.

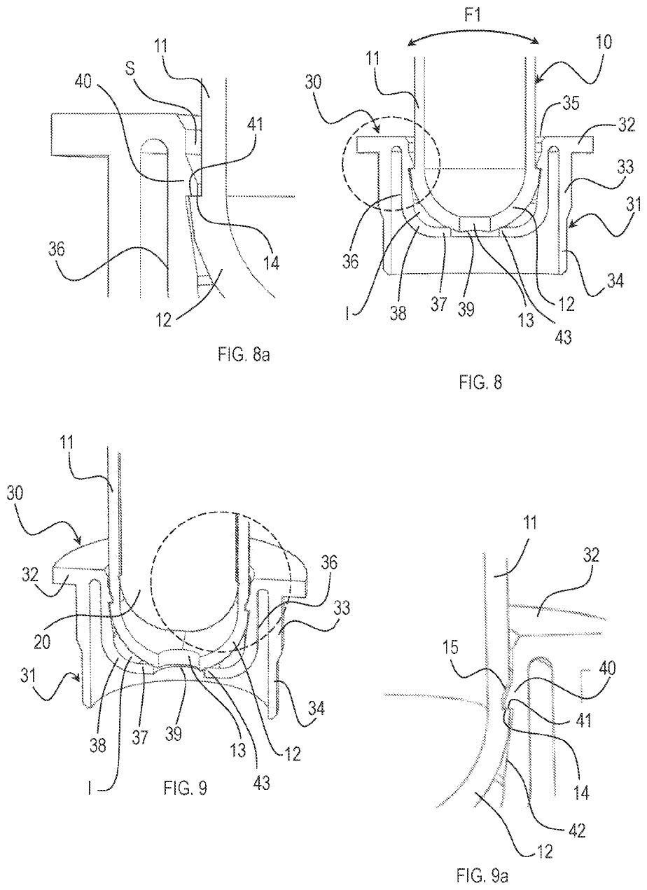

The side wall 36 of the inner seat 35 is preferably suitably spaced from an internal surface of the hollow cylindrical body 31, so that, during the step for coupling the dosing syringe 100 with the adapter 30, the side wall 36 can deform, widening at the flange 32. Moreover, the rounded edge 38 of the plane bottom wall 37 preferably has a radius of curvature lower than that of the hemispherical proximal end 12 of the hollow cylindrical body 10 of the dosing syringe 100, whereby, when the dosing syringe 100 is coupled to the adapter 30, an interspace I, shown in the FIGS. 8 and 9, is delimited at the rounded edge 38, between the hemispherical proximal end 12 and the seat 35.

As a result, when it is housed with releasable snap-fit in the seat 35, the hemispherical proximal end 12 is not in contact with the seat 35 at the rounded edge 38 of the plane bottom wall 37. This advantageously allows to avoid compromising the liquid tightness between the adapter 30 and the dosing syringe 100 and, at the same time, to facilitate the operation of disengagement of the dosing syringe 100 from the adapter 30 at the end of aspiration of the desired dose of drug. In particular, the coupling force between the dosing syringe and the adapter is advantageously located at the apertures 13 and 39, respectively of the dosing syringe 100 and of the adapter 30, i.e. at the zone of passage of the drug from the vial 50 to the dosing syringe 100.

An annular tooth 40 extends from an inner surface of the side wall 36 of the seat 35 and has a profile complementary to that of the groove(s) 15 formed in the hollow cylindrical body 10 of the dosing syringe 100 and forms a preferably plane annular surface 41, normal to the longitudinal axis of the adapter 30, against which the abutment surface 14 of the hollow cylindrical body 10 of the dosing syringe 100 abuts for the coupling between the dosing syringe and the adapter.

The distance between the aperture 39 of the bottom wall 37 of the seat 35 and the annular surface 41 of the annular tooth 40 is smaller than the distance between the aperture 13 of the hemispherical proximal end 12 and the abutment surface 14 of the dosing syringe 100. This advantageously allows the hemispherical proximal end 12 of the dosing syringe 100 to be maintained compressed inside the seat 35, increasing the coupling force between the dosing syringe and the adapter, and therefore the liquid tightness during the step of aspiration of the drug from the vial 50 to the dosing syringe 100.

Moreover, an annular countersink 42, being also preferably annular, is preferably formed in the internal surface of the side wall 26 of the seat 35, immediately below the annular surface 41, whose function will appear more clearly in the following description.

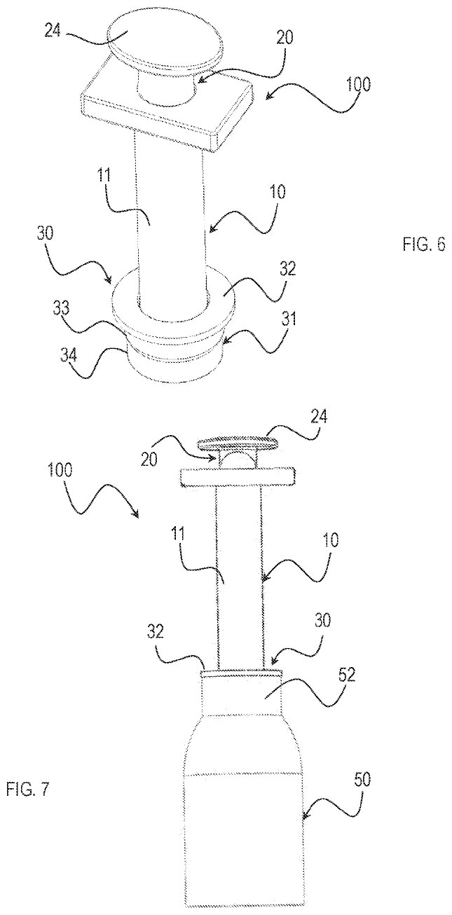

With reference to FIGS. 7, 8-8a and 9-9a, the method of coupling and uncoupling the dosing syringe 100 and the respective adapter 30 therebetween, for aspirating a drug from the vial 50 containing it will now be described in detail.

First, the adapter 30 is inserted into the opening 52 of the vial 50 until the flange 32 of the adapter 30 abuts against the opening 52. In the inserted condition, the first portion 33 of the adapter seals against an inner surface of the vial 50.

The hemispherical proximal end 12 of the dosing syringe 100 is then inserted into the respective seat 35 formed in the adapter 30 until the abutment surface 14 is coupled by snap-fit under the annular tooth 40 of the adapter 30 abutting against the corresponding annular surface 41 of the annular tooth 40, with consequent snap-fit coupling between the dosing syringe and the adapter. The correct snap-fit coupling between the dosing syringe 100 and the adapter 30 is advantageously signalled acoustically by a “click”.

In the condition of correct coupling between the dosing syringe 100 and the adapter 30, and as shown in detail in FIGS. 8 and 9, the aperture 13 of the hemispherical end 12 of the syringe is kept in position, in contact and coaxial, with the aperture 39 formed in the plane bottom 37 of the adapter 30, due to the elastic reaction that a perimeter edge 43 of the aperture 39 exerts against the outer surface of the hemispherical end 12 at the aperture 13. More particularly, the deformation of the perimeter edge 43 against the outer surface of the hemispherical end 12 at the aperture 13 generates relatively high and concentrated localized pressures, which prevent the drug from entering the gap I. The apertures 13 and 39 are therefore in direct fluid communication therebetween. In this way, during the aspiration of the drug from the vial 50, the outer surface of the hemispherical proximal end 12 of the dosing syringe 100 and the seat 35 of the adapter 30 do not come into contact with the drug, and therefore do not get soiled.

At this point, the dosing syringe 100, in particular the hollow cylindrical body 10 thereof, is completely fixed and stationary in the hooking position with the adapter 30, with the hemispherical proximal end 12 housed in the seat 35 of the adapter, pressed between the annular edge 43 of the aperture 39 and the annular abutment surface 41. It is therefore possible to move the plunger 20 back inside the hollow cylindrical body 10, so as to aspirate the desired amount of drug into the dosing syringe 100.

In order to disengage the dosing syringe 100 from the adapter 30 at the end of the aspiration step, the hollow cylindrical body 10 is inclined in a plane passing through the minor axis of the elliptical section of the main body 11 of the hollow cylindrical body 10 of the dosing syringe 100 (see arrow F1 in FIG. 8), so as to disengage the abutment surface 14 from the corresponding annular surface 41 of the annular tooth 40. The inclination of the hollow cylindrical body 10 is made possible by the presence of a space S between the outer surface of the main body 11 and the inner surface of the seat 35. In this zone, in fact, the main body 11 with elliptical cross-section of the syringe 100 is more spaced from the adapter 30.

The disengagement of the dosing syringe 100 from the adapter 30 is also facilitated by the presence of the groove(s) 15 formed in the hollow cylindrical body 10 and of the annular countersink 42 formed in the seat 35 of the adapter 30. The groove(s) 15 and the annular countersink 42 in fact create disengagement regions, i.e. regions of absence of contact between the dosing syringe 100 and the adapter 30.

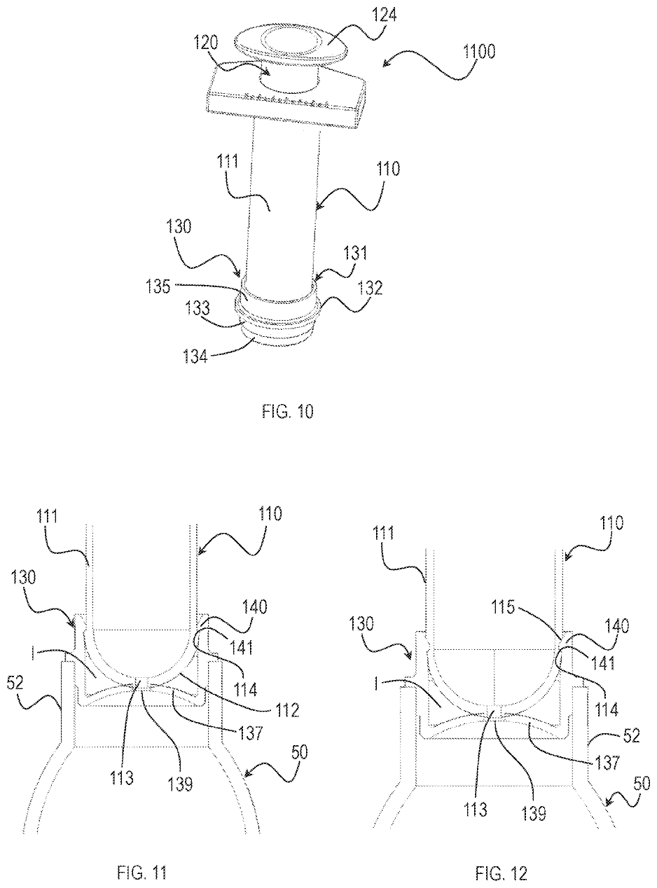

With reference to FIGS. 10 to 12, they show a dosing syringe and a relative adapter in accordance with a second alternative embodiment of the present invention.

The dosing syringe, generally designated by the reference numeral 1100 and the adapter, generally designated by the reference numeral 130, are completely similar to the dosing syringe 100 and the adapter 30 described and shown above, from which they differ in the different shape of the respective abutment surfaces for the engagement by releasable snap-fit between the dosing syringe and the adapter. Moreover, unlike the adapter 30, the adapter 130 has a portion of the hollow cylindrical body which, when the adapter is coupled to the vial, extends externally to the opening of the vial.

The dosing syringe 1100 then comprises a hollow cylindrical body 110, typically transparent, and a plunger 120 having an elliptical cross-section and provided with a distal head 124 and sliding within the hollow cylindrical body 110 to aspirate into the hollow cylindrical body 110, and then dispense from the hollow cylindrical body 110, a desired volume of product.

The hollow cylindrical body 110 comprises a main body 111, with elliptical cross-section and within which the plunger 120 slides, and a hemispherical proximal end 112, provided with an aperture 113 for the aspiration/delivery of the product into/from the hollow cylindrical body 110 of the dosing syringe 1100.

A preferably plane surface 114 inclined with respect to the longitudinal axis of the dosing syringe 1100 is formed at the zone of passage from the hemispherical proximal end 112 to the main body 111 of the hollow cylindrical body 110. Similarly to the surface 14 of the dosing syringe 100, the surface 114 has a non-uniform transverse extension, i.e. variable along the perimeter of the main body 111 of the hollow cylindrical body 110, and is configured to abut against a corresponding surface of the adapter 130, during the step of coupling the dosing syringe 1100 with the adapter 130.

Two grooves 115 are also formed on the outer surface of the main body 111, immediately above the surface 114, which are completely similar to the grooves 15 of the dosing syringe 100, and therefore not further described.

The adapter 130 comprises a hollow cylindrical body 131 and a flange 132 configured to abut, in use, against the opening 52 of the vial 50 in which the adapter 130 is inserted. The hollow cylindrical body 131 comprises a first portion 133, extending at the bottom from the flange 132, and configured to seal against the opening 52 of the vial 50, followed by a second portion 134, having an outer diameter smaller than the outer diameter of the first portion 133 to facilitate the insertion of the adapter 130 into the vial 50. The hollow cylindrical body 131 further comprises a third portion 135 extending above the flange 132 and outside the vial 50, when the adapter is in the position of use.

The adapter 130 also has a bottom wall 137, which delimits, inside the adapter 130, a seat for housing the hemispherical proximal end 112 of the dosing syringe 1100. The bottom wall 137 is arched upwards so that, when the dosing syringe 1100 is coupled to the adapter 130, an interspace I is created between the hemispherical proximal end 112 and the bottom wall 137. The bottom wall 137 is further provided with a central aperture 139 having a diameter different, for example greater than, from the diameter of the aperture 113 of the hemispherical proximal end 112 of the dosing syringe 1100.

An annular tooth 140 extends from an inner wall of the hollow cylindrical body 131, above the bottom wall 137 and preferably at the opening of the hollow cylindrical body 131. The annular tooth 140 has a profile complementary to that of the grooves 115 formed in the hollow cylindrical body 110 of the dosing syringe 1100 and forms an annular surface 141, preferably plane, inclined with respect to the longitudinal axis of the adapter 130, against which the inclined surface 114 of the hollow cylindrical body 110 of the dosing syringe 1100 abuts, for the coupling by releasable snap-fit between the dosing syringe and the adapter. The inclined annular surface 141 of the adapter is complementary to the inclined surface 114 of the dosing syringe.

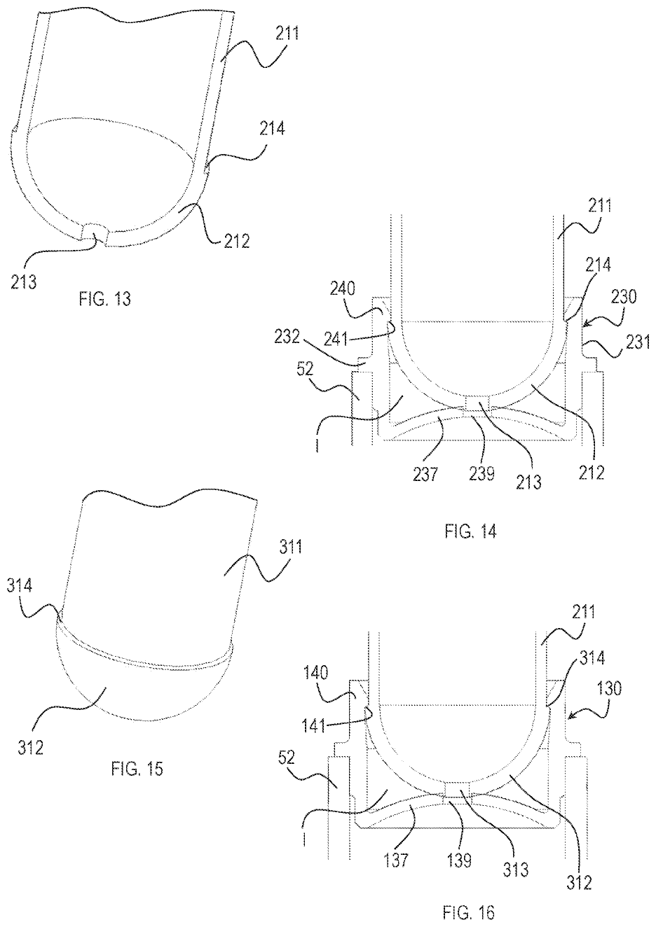

With reference to FIGS. 13 and 14, they show a detail of a dosing syringe and a relative adapter according to a third preferred embodiment of the present invention.

The dosing syringe comprises a main body 211 and a hemispherical proximal end 212 provided with an aperture 213 and differs from the dosing syringes described and shown above in that the main body 211 has a circular cross-section, instead of elliptical, and smaller than the circular cross-section of the hemispherical proximal end 212. As a result, an annular surface 214 is delimited between the main body 211 and the hemispherical proximal end 212 and extends orthogonally to the longitudinal axis of the dosing syringe.

The adapter, generally designated by the reference numeral 230, is wholly similar to that shown in FIGS. 10 to 12, from which it differs in that it comprises an annular surface, for abutment of the corresponding annular surface 214 of the syringe, inclined, instead of orthogonal, with respect to the longitudinal axis of the dosing syringe.

The adapter 230 therefore comprises a hollow cylindrical body 231 and a flange 232 configured to abut, in use, against the opening 52 of the vial 50 in which the adapter 230 is inserted.

The adapter 230 also has a bottom wall 237, which delimits, inside the adapter 230, a seat for housing the hemispherical proximal end 212 of the dosing syringe. The bottom wall 237 is arched upwards so that, when the dosing syringe is coupled to the adapter 230, an interspace I is created between the hemispherical proximal end 212 and the bottom wall 237. The bottom wall 237 is further provided with a central aperture 239 having a diameter different, for example greater than, from the diameter of the aperture 213 of the hemispherical proximal end 212 of the dosing syringe.

An annular tooth 240 extends from an inner wall of the hollow cylindrical body 231, above the bottom wall 237 and preferably at the opening of the hollow cylindrical body 231, and forms an annular surface 241, inclined with respect to the longitudinal axis of the adapter 230, against which the inclined annular surface 214 of the dosing syringe abuts, in use, for the coupling by releasable snap-fit between the dosing syringe and the adapter. The abutting surfaces 214 and 241 are complementary to each other.

Naturally, and without departing from the scope of the present invention, the dosing syringe according to said third embodiment can also be coupled to an adapter of the type shown in FIGS. 4 and 5.

With reference to FIGS. 15 and 16, they show a detail of a dosing syringe according to a fourth preferred embodiment of the present invention and a relative adapter.

The dosing syringe comprises a main body 311 and a hemispherical proximal end 312 provided with an aperture 313 and differs from the dosing syringe according to the third embodiment, shown in FIGS. 13 and 14, in that an annular surface 314 is delimited between the main body 311 and the hemispherical proximal end 312 and is inclined, instead of orthogonal, with respect to the longitudinal axis of the dosing syringe.

The adapter corresponds to the adapter 130 shown above, so it will not be further described. However, and without departing from the scope of the present invention, the hemispherical proximal end 312 of the dosing syringe according to said third embodiment may also be coupled to an adapter of the type shown in FIGS. 4 and 5.

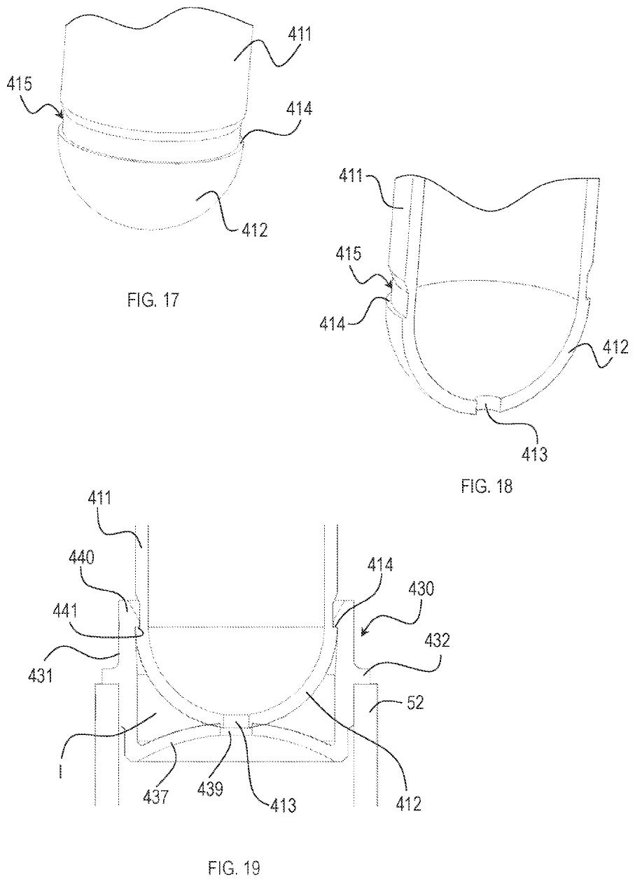

With reference to FIGS. 17 to 19, they show a detail of a dosing syringe according to a fifth preferred embodiment of the present invention and a relative adapter.

The dosing syringe comprises a main body 411 and a hemispherical proximal end 412 provided with an aperture 413 and differs from the dosing syringes described and shown above in that the main body 411 has a circular cross-section, instead of elliptical, equal to the circular cross-section of the hemispherical proximal end 412. An annular groove 415 is also formed in the main body 411, near the hemispherical proximal end 412 and which has a bottom surface 414 which forms the annular surface between the main body 411 and the hemispherical proximal end 412. The annular surface 414 is orthogonal with respect to the longitudinal axis of the dosing syringe.

The adapter, generally designated by the reference numeral 430, is entirely similar to the adapter 230, described and shown above, from which it differs in that it comprises an annular tooth 440 configured to be housed inside the annular groove 415 of the main body 411 of the dosing syringe.

The adapter 430 therefore comprises a hollow cylindrical body 431 and a flange 432 configured to abut, in use, against the opening 52 of the vial 50 in which the adapter 430 is inserted.

The adapter 430 also has a bottom wall 437, which delimits, inside the adapter 430, a seat for housing the hemispherical proximal end 412 of the dosing syringe. The bottom wall 437 is arched upwards so that, when the dosing syringe is coupled to the adapter 430, an interspace I is created between the hemispherical proximal end 412 and the bottom wall 437. The bottom wall 437 is further provided with a central aperture 439 having a diameter different, for example greater than, from the diameter of the aperture 413 of the hemispherical proximal end 412 of the dosing syringe.

An annular tooth 440 extends from an inner wall of the hollow cylindrical body 431, above the bottom wall 437 and preferably at the opening of the hollow cylindrical body 431 and which is configured to be housed inside the annular groove 415 of the main body 411 of the dosing syringe. The annular tooth 440 forms an annular surface 441, orthogonal with respect to the longitudinal axis of the adapter 430, against which, in use, the bottom surface 414 of the dosing syringe abuts, for the coupling by releasable snap-fit between the dosing syringe and the adapter.

Naturally, and without departing from the scope of the present invention, the hemispherical proximal end 412 of the dosing syringe according to the fifth embodiment shown in FIGS. 17 and 18 may also be coupled to an adapter of the type shown in FIGS. 4 and 5.

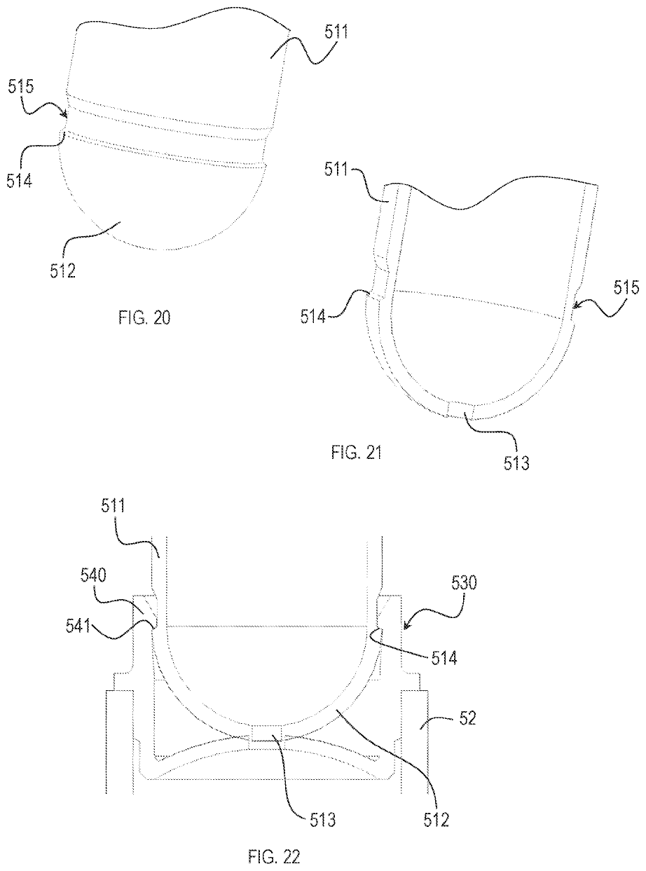

With reference to FIGS. 20 to 22, they show a detail of a dosing syringe according to a sixth preferred embodiment of the present invention and a relative adapter.

The dosing syringe according to the sixth embodiment comprises a main body 511 and a hemispherical proximal end 512 provided with an aperture 513 and differs from the dosing syringe according to the fifth embodiment, shown in FIGS. 17 to 19, in that it comprises an annular groove 515, the bottom surface 514 of which is inclined, instead of orthogonal, with respect to the longitudinal axis of the dosing syringe.

The adapter, generally designated by the reference numeral 530, corresponds to the adapter 430 shown above, from which it differs in that it comprises an annular tooth 540 which forms an annular surface 541 that is inclined, instead of orthogonal, with respect to the longitudinal axis of the adapter 530, against which the bottom surface 514 of the dosing syringe abuts, in use, for the coupling by releasable snap-fit between the dosing syringe and the adapter. The abutting surfaces 514 and 541 are complementary to each other.

Naturally, and without departing from the scope of the present invention, the hemispherical proximal end 512 of the dosing syringe according to said sixth embodiment can also be coupled to an adapter of the type shown in FIGS. 4 and 5.

The method of coupling and decoupling between the dosing syringes according to the second to sixth embodiments and the respective adapter described and shown above for aspirating a drug from a vial 50 containing it is similar to that described above with reference to the dosing syringe 100 and the adapter 30. In particular, and advantageously, the presence of the abutment surfaces 114, 514 and 141, 541 that are inclined, instead of orthogonal with respect to the longitudinal axis of the dosing syringe and of the adapter, further facilitates the operation of disengagement of the dosing syringe from the adapter.

From the above description the characteristics of the dosing syringe and the relative adapter of the present invention are clear, as are the relative advantages.

In particular, the dosing syringe, and the relative adapter, allow aspirating all the product contained in a vial or bottle, thus avoiding that the product is wasted and that an amount of product higher than that desired is administered. The liquid tightness during the step of aspirating the product is also guaranteed. Finally, the dosing syringe is comfortable for the subject to whom the product is to be administered not causing pain or minor injury to the subject.

Finally, it is clear that the dosing syringe and the adapter thus conceived are susceptible of numerous modifications and variations; moreover, all the details can be replaced by technically equivalent elements. In practice, the materials used, as well as the dimensions thereof, can be of any type according to the technical requirements. In particular, each syringe may be coupled to one of the described adapters. For example, and without departing from the scope of protection of the present invention, a dosing syringe having an abutment surface orthogonal to its longitudinal axis may be coupled to an adapter having an abutting surface of the abutment surface of the syringe inclined with respect to the longitudinal axis or a dosing syringe having an abutment surface inclined with respect to its longitudinal axis may be coupled to an adapter having an abutting surface of the abutment surface of the syringe orthogonal with respect to the longitudinal axis.

Furthermore, although dosing syringes having a hemispherical proximal end have been described in the embodiments, dosing syringes having a semi-ellipsoidal or elongated proximal end and having a circular cross-section may also be provided.

1-16. (canceled)

17. A dosing syringe comprising: a hollow cylindrical body and a plunger sliding within the hollow cylindrical body, the hollow cylindrical body comprising a main body and a proximal end provided with an aperture;
wherein the main body has at least one portion having a cross-section smaller than that of the proximal end, wherein a surface is delimited between the main body and the proximal end, which is configured to abut against a corresponding surface of an adapter, so that the proximal end is removable and liquid-tight blocked between said surface of the adapter and a bottom wall provided with an aperture of the adapter, the aperture of the proximal end and the aperture of the bottom wall being in direct fluid communication therebetween.

18. A dosing syringe according to claim 17, wherein said main body has an elliptical cross-section and said proximal end is hemispherical and comprises at least one groove formed on an external surface of the main body that extends along a perimeter length of the main body, immediately above said abutment surface and at an end of the major axis of the elliptical cross-section of the main body.

19. A dosing syringe according to claim 17, wherein said proximal end is hemispherical and said main body has a circular cross-section which is smaller than the diameter of the hemispherical proximal end.

20. A dosing syringe according to claim 17, wherein said proximal end is hemispherical and said main body has circular cross-section equal to the diameter of the hemispherical proximal end and, hemispherical proximal end comprises an annular groove formed in the main body, a lower surface of the main body comprises the abutment surface against the adapter.

21. A dosing syringe according to claim 17, wherein said surface between the main body and the proximal end, for abutment against the adapter, is orthogonal or inclined with respect to a longitudinal axis of the dosing syringe.

22. A dosing syringe according to claim 18, wherein said at least one groove comprises two grooves, each extending at a respective end of the major axis of the elliptical cross-section of the main body.

23. An adapter for use with the dosing syringe according to claim 17, comprising a hollow cylindrical body and a flange extending from the hollow cylindrical body;
wherein the hollow cylindrical body comprises a bottom wall including an aperture configured to abut against the hemispherical proximal end of the dosing syringe, and an annular tooth extending internally to the hollow cylindrical and above the bottom wall, and which delimits an annular surface configured to abut against the abutment surface of the hollow cylindrical body of the dosing syringe.

24. An adapter according to claim 23, wherein said annular tooth is complementary to that of at least one groove formed in the hollow cylindrical body of the dosing syringe.

25. An adapter according to claim 23, wherein said aperture has a diameter different from the diameter of the aperture of the proximal end of the dosing syringe and is coaxial and in direct fluid communication with the aperture of the proximal end of the dosing syringe, wherein the dosing syringe is coupled to the adapter.

26. An adapter according to claim 23, wherein the distance between the aperture of the bottom wall and the annular surface of the annular tooth is smaller than the distance between the aperture of the proximal end and the abutment surface of the dosing syringe.

27. An adapter according to claim 23, further comprising a seat housing the proximal hemispherical end of the hollow cylindrical body of the dosing syringe, said bottom wall comprising a plane bottom with a rounded edge of said seat, said rounded edge having a radius of curvature lower than that of the proximal hemispherical end, wherein, when the dosing syringe is coupled to the adapter, an interspace is delimited at the rounded edge, between the proximal end and the seat.

28. An adapter according to claim 27, wherein said seat has a side wall spaced from an internal surface of the hollow cylindrical body.

29. An adapter according to claim 28, wherein an annular countersink is formed in an internal surface of the side wall, immediately below the plane annular surface.

30. An adapter according to claim 23, wherein said bottom wall is arched upwards, so that when the dosing syringe is coupled to the adapter, an interspace is delimited between the proximal end and the bottom wall.

31. An adapter according to claim 23, wherein the annular surface of the annular tooth is orthogonal or inclined with respect to a longitudinal axis of the adapter.

32. A kit for administering a product in liquid or semi-liquid form comprising a dosing syringe comprising a hollow cylindrical body and a plunger sliding within the hollow cylindrical body, the hollow cylindrical body comprising a main body and a proximal end provided with an aperture;
wherein the main body has at least one portion having a cross-section smaller than that of the proximal end, wherein a surface is delimited between the main body and the proximal end, which is configured to abut against a corresponding surface of an adapter, so that the proximal end is removable and liquid-tight blocked between said surface of the adapter and a bottom wall provided with an aperture of the adapter, the aperture of the proximal end and the aperture of the bottom wall being in direct fluid communication therebetween; and
the adapter comprises a hollow cylindrical body and a flange extending from the hollow cylindrical body;
wherein the hollow cylindrical body comprises a bottom wall including an aperture configured to abut against the hemispherical proximal end of the dosing syringe, and an annular tooth extending internally to the hollow cylindrical and above the bottom wall, and which delimits an annular surface configured to abut against the abutment surface of the hollow cylindrical body of the dosing syringe.
